(19) United States
(12) Patent Application Publication
(10) Pub. No.: US 2010/0296005 A1
(43) Pub. Date: Nov. 25, 2010

(54) DISCHARGE TUBE, LIGHTING DEVICE, DISPLAY DEVICE, AND TELEVISION RECEIVER

(75) Inventor: Takahiro Yoshikawa, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/864,052

(22) PCT Filed: Oct. 2, 2008
(86) PCT No.: PCT/JP2008/067889

§ 371 Date: Jul. 22, 2010

(30) Foreign Application Priority Data
Feb. 19, 2008 (JP) 2008-037498

(51) Int. Cl. H04N 5/44; H01J 5/50; F21V 21/00; G02F 1/1335

(52) U.S. Cl. 348/725; 313/318.03; 362/217.01; 362/217.17; 349/61; 348/E05.096

(57) ABSTRACT

A discharge tube 17 of the present invention includes a glass tube 30, a ferrule 40 attached to an end of the glass tube 30, and lead wires 32a and 32b provided at an end of the glass tube 30. The lead wires 32a and 32b are bent and inserted in the ferrule 40 such that they are in contact with the ferrule 40. They can receive external power supply via the ferrule 40. The lead wires 32a and 32b that are non-light-emitting portions of the discharge tube 17 are bent and thus the apparent lengths of the lead wires 32a and 32b can be reduced. The light emitting area of the discharge tube 17 with respect to the whole length is increased.

### TECHNICAL FIELD

The present invention relates to a discharge tube, a lighting device, a display device, and a television receiver.

### BACKGROUND ART

In a display device using non-light emitting optical components, such as a liquid crystal display device, a backlight unit is provided for illuminating a display panel such as a liquid crystal panel. The backlight unit includes a plurality of discharge tubes as light sources, a chassis for housing the discharge tubes, and an external power source for supplying drive power to the discharge tube. A well-known discharge tube includes a fluorescent substance applied to the inner wall of a glass tube and an inert gas (such as argon) and mercury enclosed inside the glass tube. Filaments are provided at the respective ends of the glass tube. When a voltage is applied across the filaments, an arc discharge occurs and light is emitted. A light emitting portion of such a discharge tube is located between the filaments.

Generally in the above-mentioned discharge tube, two lead wires connected with filaments are pulled out of the glass tube along the axial direction of the discharge tube. When using the discharge tube in a backlight unit, the lead wires pulled out from the end thereof are connected with harnesses that are electrically connected to an external power source inside a chassis. Since the lead wire is pulled out in the axial direction of the discharge tube and the discharge tube is housed in the chassis, a size of the chassis needs to be large enough to accommodate the length of the lead wires outside the glass tube plus the axial length of the glass tube. For the size of the chassis, an area of the light emitting portion of the discharge tube, that is, a portion of the discharge tube from which illuminating light is output is small.

To solve the above problem, a straight discharge tube disclosed in Patent Document 1 includes lead wires of electrodes provided at ends of the discharge tube, the lead wires being pulled out in a direction perpendicular to the axial direction of the discharge tube. Space for the lead wires is not required in the axial direction of the discharge tube in a chassis for housing such a discharge tube. Therefore, a relatively large area from which illuminating light is output can be provided.

[Patent literature 1]: Japanese Unexamined Patent Application Publication No. H11-213951 A

### Problem to be Solved by the Invention

However, the lead wires of the discharge tube disclosed in Patent Document 1, which are pulled out in the direction perpendicular to the axial direction of the discharge tube, need to be connected with harnesses to receive electrode supply from an external power source. Namely, time-consuming connecting work is required. Moreover, the lead wires pulled out of the glass tube are thin wires and subjected to bending due bending stress caused by contact. In some cases, unexpected deformation occurs.

### DISCLOSURE OF THE INVENTION

The present invention is completed based on the above circumstances. An object of the present invention is to provide a discharge tube having a large area of light emitting portion with respect to the whole length and a structure that provides easy electrical connection to an external power source. Another object of the present invention is to provide a lighting device including such a discharge tube to provide a wide illuminating range and high yield. Still another object is to provide a display device including such a lighting device and a television receiver including the display device.

### Means for Solving the Problem

To solve the above problems, a discharge tube in the present invention includes a glass tube, a ferrule and a lead wire. The ferrule is attached to an end of the glass tube. The lead wire is provided at the end of the glass tube. The lead wire is bent and inserted in the ferrule such that the lead wire is in contact with the ferrule. The lead wire is electrically connected to an external power supply via the ferrule.

By bending a lead wire provided at the end of a glass tube and inserting it in a ferrule, an apparent length of the lead wire is shorter than an actual length. In other words, in comparison to a lead wire pulled out from the glass tube in the axial direction and used as it is, the ratio of the apparent length of the lead wire with respect to the whole length of the discharge tube can be reduced. The lead wire is a conductive wire for receiving external power supply and included in a non-light-emitting portion of the discharge tube. Therefore, the light emitting portion of the discharge tube is reduced by the length of the lead wire with respect to the whole length of the discharge tube. By bending the lead wire, the ratio of the apparent length of the lead wire with respect to the whole length of the discharge tube is reduced and thus the ratio of the light emitting portion of the discharge tube increases.

Furthermore, the bent lead wire is in contact with a ferrule and thus can receive power supply from the outside via the ferrule. In a known technology, an end of a lead wire that is pulled out from a glass tube is connected with a harness for receiving external power supply. The connecting work is time-consuming. Moreover, the lead wire is a thin wire and thus brittle to bending stress caused by contacts. In some cases, it is deforms unintentionally. The lead wire according to the present invention is inserted in the ferrule attached to an end of a glass tube such that the lead wire comes into contact with a ferrule for receiving external power supply via the ferrule. The unintentional deformation of the lead wire due to linearity of the lead wire does not occur when connecting the discharge tube to an external power source. Therefore, the external power supply to the discharge tube can be achieved easily and properly.

### BRIEF DESCRIPTION OF THE DRAWINGS

FIG. 1 is an exploded perspective view showing a general configuration of a television receiver according to the first embodiment in the present invention;

FIG. 2 is an exploded perspective view showing a general configuration of a liquid crystal display device included in the television receiver in FIG. 1;

FIG. 3 is a cross-sectional view taken along a line A-A of the liquid crystal display device shown in FIG. 2;

FIG. 4 is a perspective view showing a general structure of a hot cathode fluorescent lamp included in the liquid crystal display device shown in FIG. 2;

FIG. 5 is a cross-sectional view showing a structure of an end of the hot cathode fluorescent lamp in FIG. 4;

FIG. 6 is an elevation view showing a structure of an end surface of the hot cathode fluorescent lamp in FIG. 4;

FIG. 7 is an elevation view showing a structure of a relay connector included in the liquid crystal display device in FIG. 2;

FIG. 8 is a top view showing a structure in which the hot cathode fluorescent lamp is mounted in the relay connector in FIG. 7;

FIG. 9 is a cross-sectional view showing a structure in which the hot cathode fluorescent lamp is mounted in the relay connector;

FIG. 10 is an enlarged cross-sectional view of a relevant part of the cross section taken along a line B-B in FIG. 8;

FIG. 11 is a cross-sectional view showing a structure of an end of a hot cathode fluorescent lamp according to the second embodiment in the present invention;

FIG. 12 is a cross-sectional view taken along a line C-C of the hot cathode fluorescent lamp shown in FIG. 11;

FIG. 13 is a cross-sectional view showing the assembling steps of the hot cathode fluorescent lamp in FIG. 11; and

FIG. 14 is a cross-sectional view showing a modification of the mounting of a hot cathode fluorescent lamp to a relay connector.

### BEST MODE FOR CARRYING OUT THE INVENTION

### First Embodiment

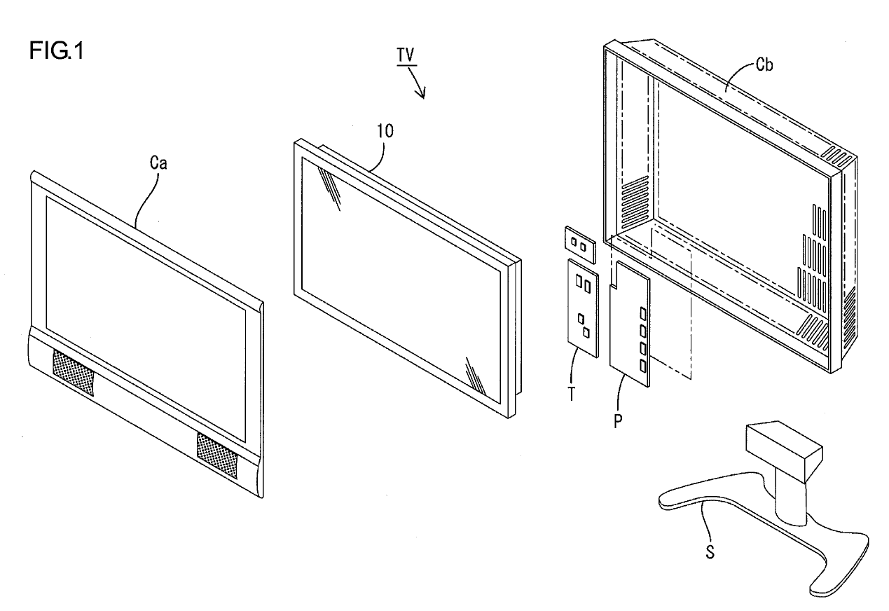

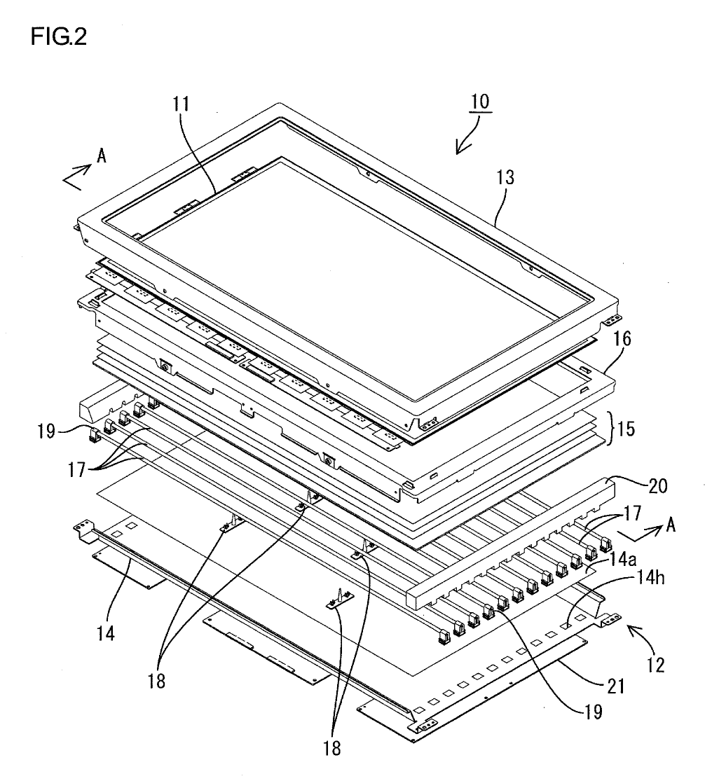

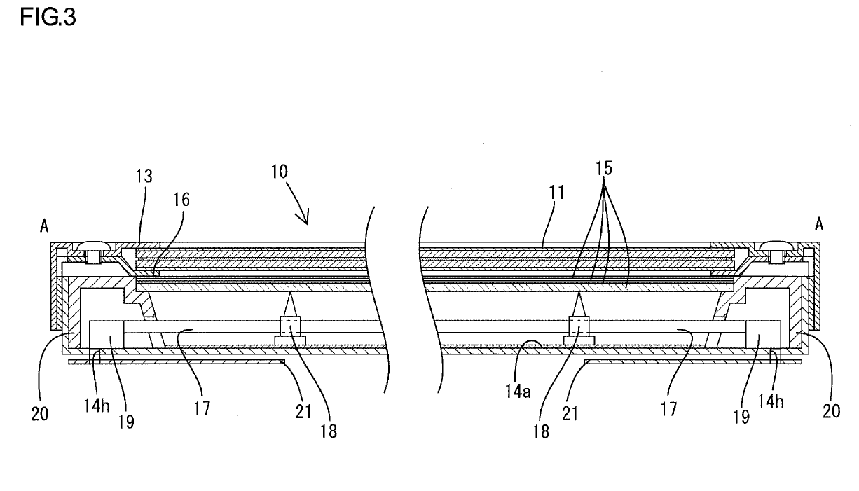

The first embodiment of the present invention will be explained in reference to FIGS. 1 to 10. Firstly, the configuration of a television receiver TV that includes a liquid crystal display device 10 will be explained below. FIG. 1 is an exploded perspective view showing a general configuration of a television receiver TV according to the present embodiment. FIG. 2 is an exploded perspective view showing a general configuration of the liquid crystal display device 10. FIG. 3 is a cross-sectional view showing a configuration of the cross-section taken along a line A-A of the liquid crystal display device 10.

As shown in FIG. 1, the television receiver TV according to the present embodiment includes a liquid crystal display device 10, front and rear cabinets Ca and Cb, a power source P, a tuner T, and a stand S. The front and the rear cabinets Ca and Cb hold and house the liquid crystal display device 10 therebetween. The liquid crystal display device (display device) 10 has a horizontally oriented rectangular overall shape and is housed in a vertical position. As shown in FIG. 2, the liquid crystal display device 10 includes a liquid crystal panel (display panel) 11 as a display panel and a backlight unit (lighting device) 12 as an external light source, and these are integrally held by a bezel 13.

Next, the liquid crystal panel 11 and the backlight unit 12 included in the liquid crystal display device 10 are explained (see FIGS. 2 and 3). The liquid crystal panel 11 includes a pair of glass substrates bonded together with a prescribed gap therebetween, and a liquid crystal sealed between the glass substrates. Switching elements (e.g., TFTs) connected to source or gate lines that are perpendicular to each other and a pixel electrode connected with the switching element are provided on one of the glass substrates. On the other glass substrate, the counter electrode and a color filter having color sections of R (red), G (green) and B (blue) arranged in a matrix.

Next, the backlight unit 12 will be explained below. The backlight unit 12 is so-called a direct backlight device and includes a plurality of discharge tubes (hot cathode fluorescent lamps 17 are used in this embodiment) arranged closely behind an opposite surface of the liquid crystal panel 11 from the panel surface (i.e., display surface) along the panel surface.

The backlight unit 12 includes a chassis 14 in a substantially box shape with an opening in the upper surface thereof, a plurality of optical members 15 (a diffuser plate, a diffuser sheet, a lens sheet and a reflection-type polarizing plate in this order from the lower side of the drawings) mounted so as to cover the opening of the chassis 14, and a frame 16 for holding these optical members 15 to the chassis 14. Furthermore, hot cathode fluorescent lamps 17, lamp clips 18, relay connectors 19 and lamp holders 20 are provided inside the chassis 14. The lamp clips 18 are provided for mounting the hot cathode fluorescent lamps 17 to the chassis 14. The relay connectors 19 are connected with ends of the hot cathode fluorescent lamps 17. The lamp holders 20 collectively cover the hot cathode fluorescent lamps 17 and the relay connectors 19. In the backlight unit 12, the light output side is located on a side closer to the optical member 15 than the hot cathode fluorescent lamp 17.

The chassis 14 is made of metal and formed into a shallow substantially box shape. It has a rectangular bottom plate and side walls standing up from respective sides of the bottom plate. In areas of the chassis 14 corresponding to ends of the hot cathode fluorescent lamps 17 (areas in which the relay connectors 19 are arranged) insertion holes 14h in which the relay connector 19 are inserted are provided. Moreover, in the chassis 14, a light reflective sheet 14a is arranged on the side opposite to the side to which light from the hot cathode fluorescent lamp 17 is output (i.e., on the inner surface of the bottom plate of the chassis 14), and a light reflecting surface is provided.

The light reflective sheet 14a is made of a synthetic resin and has a surface in white that is superior in the light reflectivity. As shown in FIG. 3, the light reflective sheet 14a is laid over substantially entire area of the inner surface of the chassis 14 so as to integrate with the inner surface. The inner surface of the chassis 14 and the light reflective sheet 14a form the bottom surface of the chassis 14. This reflective sheet 14 reflects the light emitted from the hot cathode fluorescent lamp 17 toward the optical member 15 including the diffuser plate.

On a surface of the chassis 14 that is an opposite surface from the surface where the reflective sheet 14a is arranged (the rear surface of the bottom plate of the chassis 14), inverter boards (external power source) 21 are mounted in respective long-side end areas of the chassis 14. Each inverter board 21 includes a circuit (not shown) including a transformer for generating a high-frequency voltage as a drive power for the hot cathode fluorescent lamp 17. The inverter board 21 supplies power from the circuit to the hot cathode fluorescent lamps 17.

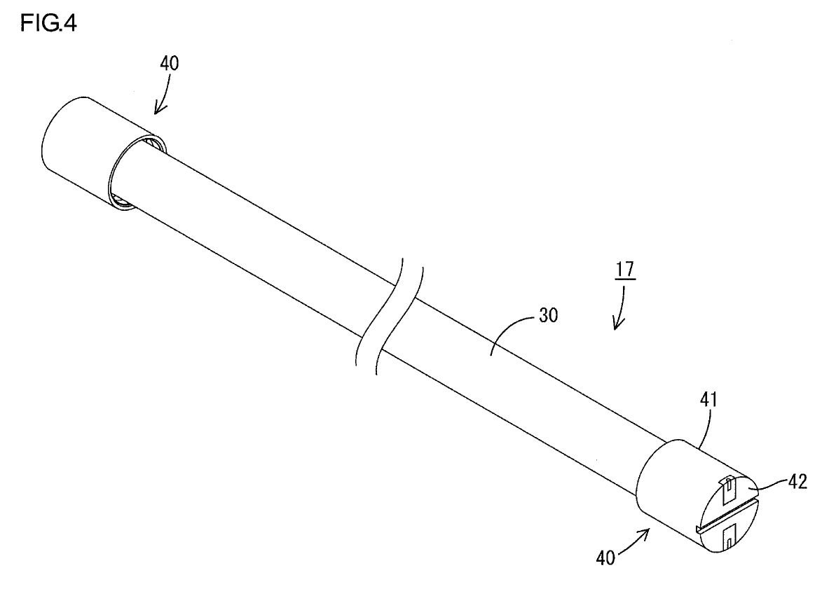

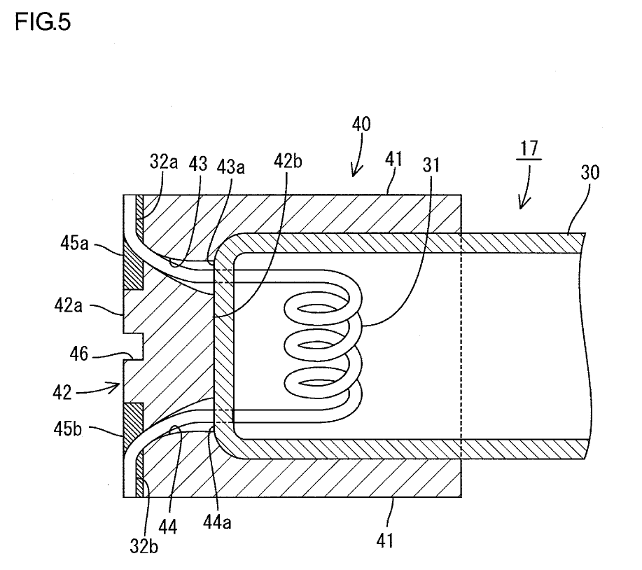

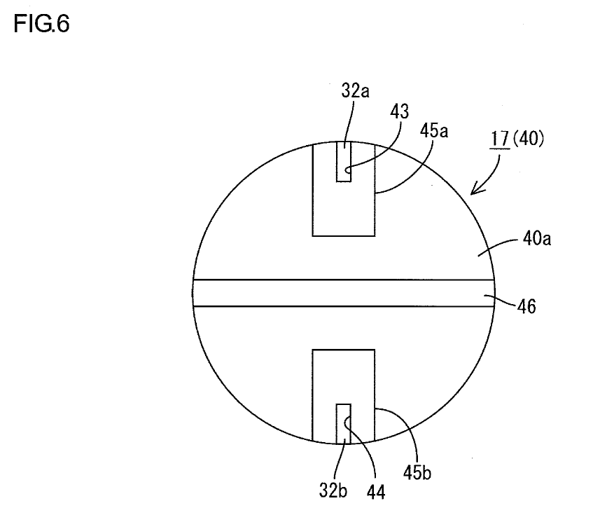

Next, the hot cathode fluorescent lamp 17 is explained in reference to FIGS. 4 to 6. FIG. 4 is a perspective view showing a general structure of the hot cathode fluorescent lamp 17; FIG. 5 is a cross-sectional view showing a structure of an end of the hot cathode fluorescent lamp 17; and FIG. 6 is an elevation view showing a structure of an end surface of the hot cathode fluorescent lamp 17. Each hot cathode fluorescent lamp 17 has an elongated tubular shape. Multiple hot cathode fluorescent lamps 17 are housed in the chassis 14 with their long-side direction (axial direction) matched with the long-side direction of the chassis 14. As shown in FIG. 4, each hot cathode fluorescent lamp 17 includes an elongated glass tube 30 with both ends sealed and ferrules 40 for covering the respective ends of the glass tube 30. Portions of the hot cathode fluorescent lamp 17 covered by the ferrules 40 are non-light-emitting portions. The middle portion that is other than the light non-light-emitting portions is a light-emitting portion.

Mercury is enclosed within the glass tube 30. Filaments 31 are arranged at both ends of the glass tube 30 as shown in FIG. 5. A first lead wire 32a and a second lead wire 32b both in a linear shape are separately pulled out of each end of the grass tube 30.

Each ferrule 40 is generally made of an nonconductive material (e.g., aluminum). It has a bottomed cylindrical shape having a peripheral wall 41 that covers the peripheral surface of the glass tube 30 and an end portion 42 opposed to (facing) the end surface of the glass tube 30. An end surface of the end portion 42 of the ferrule 40 located on an opposite side from the glass tube 30, that is, an outer end surface 42a of the end portion 42 is substantially perpendicular to the axial direction of the glass tube 30. A first insertion hole 43 and a second insertion hole 44 are formed in the end portion 42 of the ferrule 40. The first insertion hole 43 and the second insertion hole 44 continues from the inner bottom surface 42b opposed to the end surface of the glass tube 30 to the outer end surface 42a. The first insertion hole 43 and the second insertion hole 44 have axes in the axial direction of the glass tube 30 in areas on the inner bottom surface 42b side and in a direction that crosses the axial direction of the glass tube 30 in areas on the outer end surface 42a side. Namely, the axes are curved from the axial direction of the glass tube 30 to the direction that crosses the axial direction in the areas from the inner bottom surface 42b to the outer end surface 42a. The first insertion hole 43 and the second insertion hole 44 are curved in opposing directions. The first insertion hole 43 is curved upwardly as shown in FIG. 5 while the second insertion hole 44 is curved into the opposite direction, in other words, curved downwardly in FIG. 5.

The first insertion hole 43 has a first opening 43a in the inner bottom surface 42b of the end portion 42. The first opening has an oval shape having a width larger than that of the first lead wire 32a pulled out from the glass tube 30. The width of the first insertion hole 43 gradually decreases from the first opening 43a to the end thereof. The width of the hole is almost the same as that of the first lead wire 32a at the end. The second insertion hole 44 has a second opening 44a in the inner bottom surface 42b of the end portion 42. The second opening has an oval shape having a width larger than that of the second lead wire 32b pulled out from the glass tube 30. The width of the second insertion hole 44 gradually decreases from the second insertion opening 44a to the tip thereof. The width of the hole is almost the same as that of the second lead wire 32b.

Power input terminals 45a and 45b made of a conductive material are mounted in the end portion 42 of the ferrule 40 on the outer end surface 42a side over the first insertion hole 43 and the second insertion hole 44, respectively. The power input terminals 45a and 45b are separated from each other and electrically independent from each other. The power input terminals 45a and 45b form parts of the inner walls of the first insertion hole 43 and the second insertion hole 44, respectively. As shown in FIG. 6, they are exposed on the outer end surface 42a of the end portion 42 of the ferrule 40. The first insertion hole 43 and the second insertion hole 44 continue to the outer end surface 42a of the end portion 42 within the surfaces on which the power input terminals 45a and 45b are exposed.

The first lead wire 32a and the second lead wire 32b pulled out from the glass tube 30 are inserted in the first insertion hole 43 and the second insertion hole 44 of the ferrule 40, respectively. They are bent along the curvature of the first insertion hole 43 and the second insertion hole 44 and exposed on the outer end surface 42a of the ferrule 40. The widths of the first insertion hole 43 and the second insertion hole 44 gradually decrease toward the ends. The inner walls of the first insertion hole 43 and the second insertion hole 44 around the ends come in contact with the first lead wire 32a and the second lead wire 32b, respectively. The power input terminals 45a and 45b form the parts of the inner walls of the first insertion hole 43 and the second insertion hole 44 around the ends as mentioned above. Therefore, the inserted first lead wire 32a and the second lead wire 32b come in contact with the power input terminals 45a and 45b, respectively. Therefore, they are electrically connected to each other.

Furthermore, in the outer end surface 42a of the ferrule 40, a grooved portion (recess) 46 is formed between the power input terminals 45a and 45b. It extends across the outer end surface 42a at the center. The grooved portion 46 is a rectangular hollow section in the cross section of the ferrule 40. It is formed toward the glass tube 30 side so as to receive the protruding portion (protrusion) 57 of the relay connector 19, which will be described later.

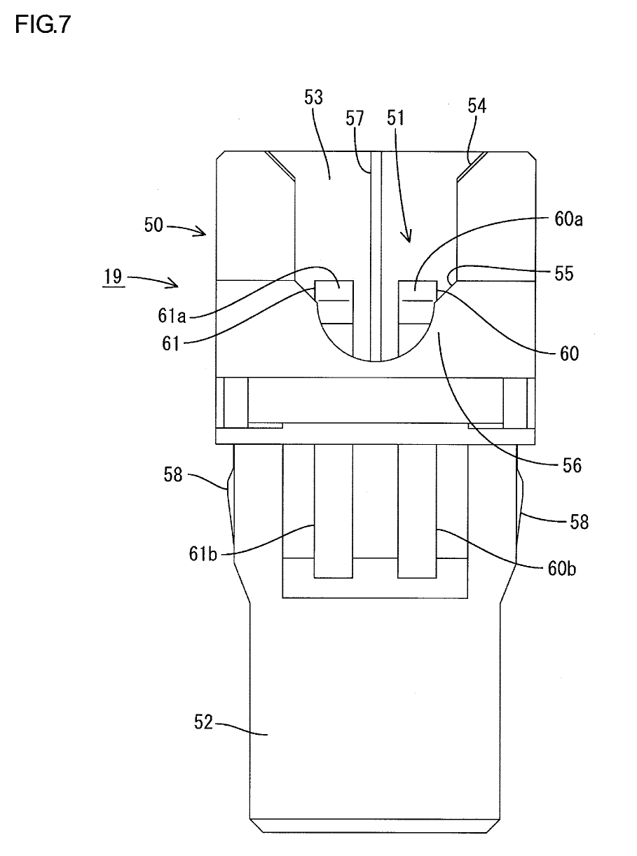

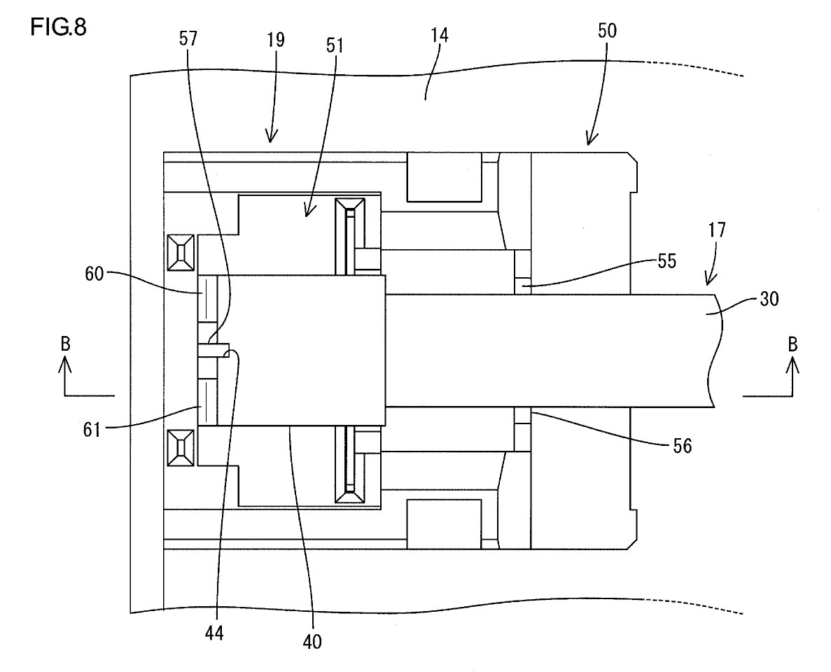

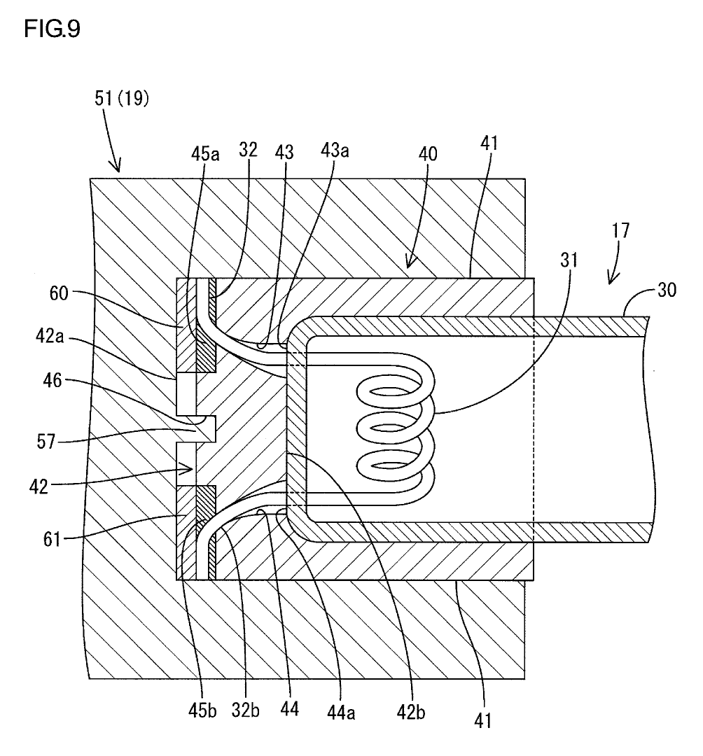

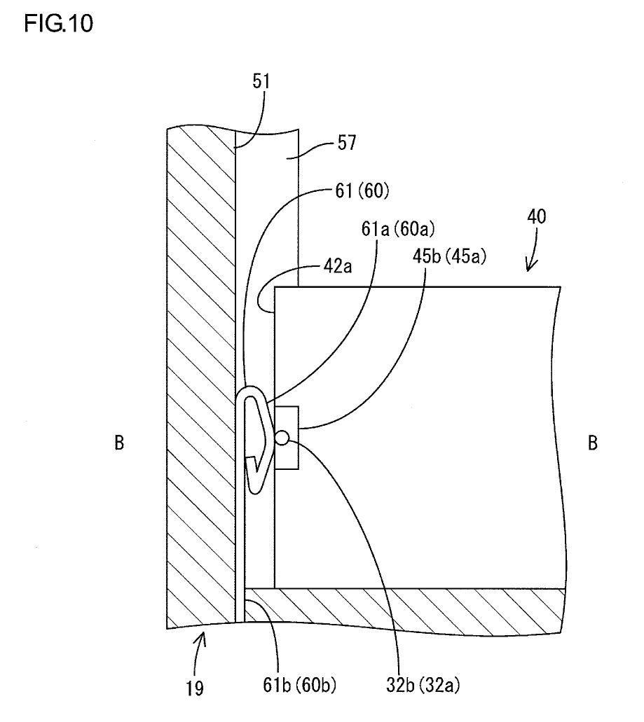

Next, the relay connector 19 connected with the end of the hot cathode fluorescent lamp 17 (i.e., the ferrule 40) will be described in reference to FIGS. 7 to 10. FIG. 7 is an elevation view showing a structure of the relay connector 19. FIG. 8 is an upper surface view of a structure in which the hot cathode fluorescent lamp 17 is mounted in the relay connector 19. FIG. 9 is a cross-sectional view showing a structure in which the hot cathode fluorescent lamp 17 is mounted in the relay connector 19. FIG. 10 is an enlarged cross-sectional view of a relevant part of the cross section taken along a line B-B in FIG. 8. The same number of the relay connectors 19 as the hot cathode fluorescent lamps 17 is arranged in each area close to either end of the long side of the chassis 14 along the short side of the chassis 14 (the parallel direction of the hot cathode fluorescent lamps 17) (see FIG. 2). Each relay connector 19 has a function for making electrical connection between the hot cathode fluorescent lamp 17 and the inverter board 21. As shown in FIG. 7, it includes a synthetic resin holder 50 and power output terminals 60 and 61 housed in the holder 50.

The holder 50 includes a socket (ferrule receiving portion) 51 generally in a block shape and a wall 52 that projects from the rear surface of the socket 51 to the bottom side (to the back surface side of the chassis 14). The socket 51 has a housing space 53, an opening of which is formed in the front surface continuously to the side surface (the side surface far from the outer edge of the chassis 14). The opening of the housing space 53 in the upper surface (the upper side in FIG. 7, the front side in FIG. 8) is a receiving opening 54 through which the ferrule 40 attached to the end of the hot cathode fluorescent lamp 17 is fitted from the upper surface side. The opening in the front surface (the front side in FIG. 7, right side in FIG. 8) is a relief opening 55. The relief opening 55 is provided so that the glass tube 30 of the hot cathode fluorescent lamp 17 is free from interference when the end of the hot cathode fluorescent lamp 17 (or the ferrule 40) is placed in the housing space 53. A stopper 56 having a semi-circular cutout is provided in the bottom of the relief opening 55 such that it juts. Namely, the relief opening 55 is formed into a nearly U shape, thereby narrowing the opening. The opening width of the relief opening 55 having a substantially U shape is smaller than the outer diameter of the ferrule 40 and equal to or slightly larger than the outer diameter of the glass tube 30.

The protruding portion (protrusion) 57 having a rectangular cross-section protrudes from a surface of the socket 51 that is opposed to the outer end surface 42a of the ferrule attached to the hot cathode fluorescent lamp 17 for a predetermined height. As shown in FIG. 9, the protruding portion 57 is located at a position such that it is fitted in the grooved portion 46 of the ferrule 40 attached to the hot cathode fluorescent lamp 17 when the hot cathode fluorescent lamp 17 is connected to the relay connector 19 at a predefined position. In other words, a position at which the hot cathode fluorescent lamp 17 is connected with the relay connector 19 is defined when the hot cathode fluorescent lamp 17 is inserted in the relay connector 19 and the protruding portion 57 is fitted in the grooved portion 46, a position at which. The protruding portion 57 and the grooved portion 46 function as a positioning guide when connecting the hot cathode fluorescent lamp 17 with the relay connector 19.

The wall 52 is a plate member that can be inserted into an insertion hole 14h provided in the chassis 14 (see FIG. 2). A pair of retainer projections 58 is formed on either side surface of the wall 52 (the right and left sides in FIG. 7). The retainer projections 58 has a function of retain the relay connector in place when the relay connector 19 is mounted to the chassis 14.

In the above socket 51, the power output terminals 60 and 61 are mounted on a surface opposed to the outer end surface 42a of the ferrule 40 attached to the hot cathode fluorescent lamp 17. The power output terminals 60 and 61 are separated (see FIG. 7) and electrically independent from each other. The power output terminals 60 and 61 are plate springs (elastic member) prepared by bending a metal plate. The power output terminals 60 and 61 have spring portions 60a and 61a, and board connecting portions 60b and 61b, respectively. The board connecting portions 60b and 61b extend in a form of a plate as shown in FIG. 10. The spring portions 60a and 61a of the power output terminals 60 and 61 come in contact with the power input terminals 45a and 45b of the ferrule 40 with the elastic deformation (see FIGS. 9 and 10). As a result, the power output terminals 60 and 61 are electrically connected with the power input terminals 45a and 45b.

The board connecting portions 60b and 61b extend along the wall 52 of the holder 50 (see FIG. 7). They are projected from the back surface of the chassis 14 together with the wall 52 and electrically connected to the inverter board 21. The board connecting portions 60b and 61b are connected to respective circuits on the inverter board 21. The circuits supply different levels of power (or voltages),respectively.

According to the present embodiment as described above, the hot cathode fluorescent lamp 17 includes the first lead wire 32a and the second lead wire 32b pulled out from the end surface of the glass tube 30 and bent. The first lead wire 32a and the second lead wire 32b are inserted in the ferrule and in contact with the ferrule 40. The ferrule 40 is attached to the end of the glass tube 30, and thus the hot cathode fluorescent lamp 17 receives external power supply via the ferrule 40. The lead wires 32a and 32b pulled out from the end of the glass tube 30 are bent and inserted in the ferrule 40. Therefore, the apparent lengths of the lead wires 32a and 32b are shorter than the actual lengths. In other words, in comparison to lead wires pulled out from the grass tube 30 in the axial direction and used as they are, the ratio of the apparent length of bent lead wires 32a and 32b with respect to the whole length of the hot cathode fluorescent lamp 17 is smaller.

Both lead wires 32a and 32b are conductive wires for the hot cathode fluorescent lamp 17 to receive electrode supply and included in the non-light-emitting portions of the hot cathode fluorescent lamp 17. Therefore, the light emitting area of the hot cathode fluorescent lamp 17 is reduced by the length of the lead wires 32a and 32b with respect to the whole length of the hot cathode fluorescent lamp 17. According to the present invention, lead wires 32a and 32b are bent and thus the light emitting area of the hot cathode fluorescent lamp 17 can be increased.

Furthermore, the bent lead wires 32a and 32b are in contact with the ferrule 40 and thus the receive electrode supply from an external power source (in the present embodiment, the inverter board 21) via the ferrule 40. This allows the time and labor required for the conventional connecting work between lead wires 32a and 32b and harnesses to be spared. Furthermore, lead wires 32a and 32b are less likely to be unexpectedly deformed due to the wires linearity, thereby ensuring and facilitating the power supply.

According to the present embodiment, the ferrule 40 includes the end portion 42 having the inner bottom surface 42a opposed to the end surface of the glass tube 30. The outer end surface 42a of the end portion 42 is substantially perpendicular to the axial direction of the glass tube 30. Because the ferrule 40 is a non-light-emitting member for covering the end of the glass tube 30, the light emitting area of the hot cathode fluorescent lamp 17 is reduced by the length of the ferrule 40 with respect to the whole length of the hot cathode fluorescent lamp 17. According to the present invention, the outer end surface 42a of the end portion 42 of the ferrule 40 is substantially perpendicular to the axial direction of the glass tube 30 and thus the ratio of the length of the ferrule 40 with respect to the whole length of the hot cathode fluorescent lamp 17 is reduced as much as possible. As a result, the light emitting portion of the hot cathode fluorescent lamp 17 can be increased.

In the present embodiment, the end portion 42 of the ferrule 40 has the insertion holes 43 and 44 in which the respective lead wires 32a and 32b are inserted. The insertion holes 43 and 44 are curved in directions that cross the axial direction of the glass tube 30. According to this configuration, in the attaching work of the ferrule 40 to the glass tube 30, the lead wires 32a and 32b are bent in directions crossing the axial direction of the glass tube 30 along the curvature of the insertion holes 43 and 44 as they are inserted in the respective insertion holes 43 and 44. As a result, a separate bending work of the lead wires 32a and 32b is not required, and thereby improving the work efficiency.

The backlight unit 12 according to the present embodiment includes the above-mentioned hot cathode fluorescent lamp 17, the inverter board 21 for supplying power to the hot cathode fluorescent lamp 17, and the chassis 14 as a mounting body for the hot cathode fluorescent lamp 17 and the inverter board 21. Each hot cathode fluorescent lamp 17 has a large light emitting area with respect to its whole length and can easily make electrical connection to the inverter board 21, which is an external power source. The backlight unit 12 includes such hot cathode fluorescent lamps 17 and thus can provide a wide illuminating range and high yield.

The backlight unit 12 according to the present embodiment includes the relay connectors 19 for making electrical connections between the inverter board 21 and the hot cathode fluorescent lamps 17 arranged in the chassis 14. Each relay connector 19 has the socket 51 in which the ferrule 40 attached to the hot cathode fluorescent lamp 17 is fitted. By fitting the ferrule 40 in the socket 51, power is supplied to the hot cathode fluorescent lamp 17.

In a known technology of electrically connecting the hot cathode fluorescent lamps 17 to the inverter board 21, the lead wires 32a and 32b pulled out from the hot cathode fluorescent lamp 17 are connected with harnesses that extend from the inverter board 21. Connecting of lead wires 32a and 32b with the harnesses is manual work in many cases and the manual work may result in broken harnesses. According to the present invention, fitting the ferrule 40 attached to an end of the hot cathode fluorescent lamp 17 in the socket 51 of the relay connector 19 ensures the electrical connection between the hot cathode fluorescent lamp 17 and the inverter board 21. Therefore, such broken harness does not occur. This can achieve an easy and certain connection.

According to the present embodiment, the ferrule 40 includes the grooved portion 46 in the outer end surface 42. The grooved portion 46 is formed toward the side of the glass tube 30. The socket 51 includes the protruding portion 57 on a surface opposed to the outer end surface 42a of the ferrule 40. The protruding portion 57 protrudes to the ferrule 40 side. When the protruding portion 57 of the socket 51 is fitted in the grooved portion 46 of the ferrule 40, the hot cathode fluorescent lamp 17 is mounted to the relay connector 19 in a predefined position.

According to such a configuration, only by fitting the protruding portion 57 of the socket 51 of the relay connector 19 in the grooved portion 46 of the ferrule 40 attached to the hot cathode fluorescent lamp 17, which is a simple work, the hot cathode fluorescent lamp 17 is mounted to the relay connector 19 in the predefined position. Therefore, the assembling work efficiency of the backlight unit 12 improves. Furthermore, the hot cathode fluorescent lamp 17 and the relay connector 19 are connected with each other with the protruding portion 57 fitted in the grooved portion 46. Therefore, the hot cathode fluorescent lamp 17 and the relay connector 19 are restricted from being misaligned once they are connected.

In the present embodiment, the power input terminals 45a and 45b are provided in the end portion 42 of the ferrule 40. They are in contact with lead wires 32a and 32b, respectively. The power output terminals 60 and 61 are provided in the socket 51. They are electrically connected to the inverter board 21. The power input terminals 45a and 45b come in contact with the power output terminals 60 and 61, respectively. As a result, the hot cathode fluorescent lamp 17 is electrically connected to the inverter board 21.

With such a configuration, power is supplied to the hot cathode fluorescent lamp 17 through the contact between the power input terminals 45a and 45b and the power output terminals 60 and 61. Therefore, variations in how to supply power to the hot cathode fluorescent lamp 17 can be produced by changing the configurations of the power input terminals 45a and 45b and the power output terminals 60 and 61. Especially in the present embodiment, the lead wire 32a connected to the power input terminal 45a and the lead wire 32b connected to the power input terminal 45b are electrically independent from each other. Furthermore, the power output terminals 60 and 61 are electrically independent from each other. They are connected to different circuits on the inverter board 21. With this configuration, different levels of power can be supplied to the first electrical system including the power output terminal 60, the power input terminal 45a and the lead wire 32a, and to the second electrical system including the power output terminal 61, the power input terminal 45b and the lead wire 32b. Therefore, the hot cathode fluorescent lamp 17 can maintain stable illumination.

The power output terminals 60 and 61 in the present embodiment are made of a plate spring as an elastic material. Accordingly, when fitting the ferrule 40 attached to the hot cathode fluorescent lamp 17 in the socket 51, the power input terminals 45a and 45b and the power output terminals 60 and 61 come in elastic contact with each other. Therefore, the power input terminals 45a and 45b or the power output terminals 60 and 61 are less likely to be damaged.

### Second Embodiment

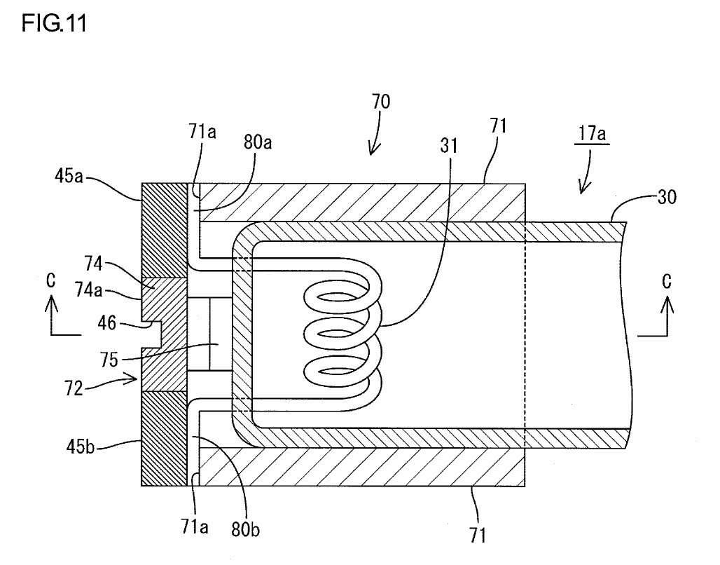

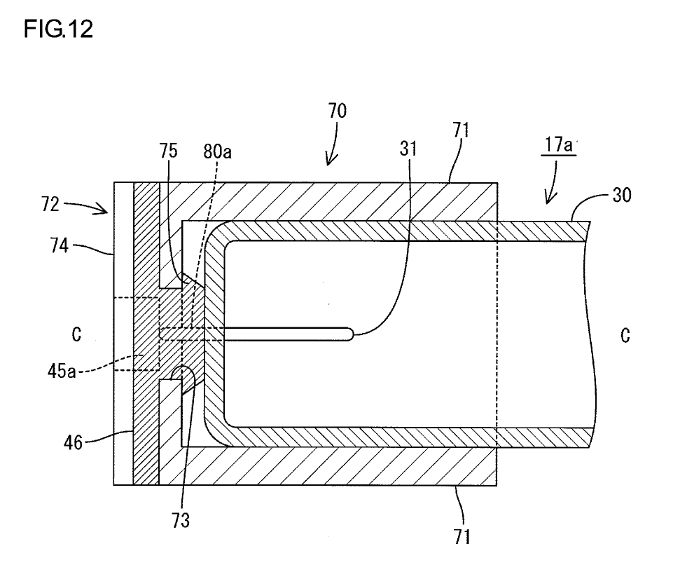

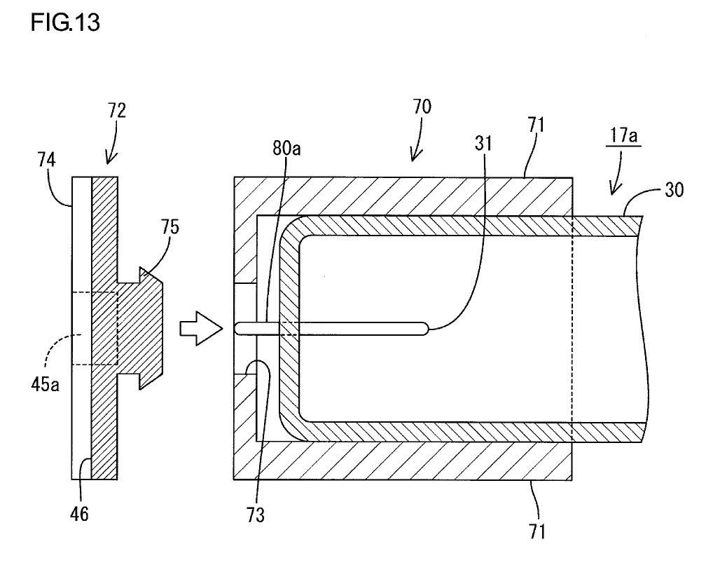

Next, the second embodiment of the present invention will be explained in reference to FIGS. 11 to 13. In the second embodiment, a configuration of a ferrule and how to bend lead wires are changed. Other configurations are the same as the above embodiment. The same parts as those in the above embodiment are indicated by the same reference symbols and will not be explained. FIG. 11 is a cross-sectional view showing a structure of an end of a hot cathode fluorescent lamp 17a according to this embodiment. FIG. 12 is a cross-sectional view taken along a line C-C in FIG. 11. FIG. 13 is a cross-sectional view showing the assembling steps of the ferrule 70 attached to the hot cathode fluorescent lamp 17a in FIG. 11.

The hot cathode fluorescent lamp 17a includes a glass tube 30 and a ferrule 70 for covering the ends of the glass tube 30. The ferrule 70 is generally made of a non-conductive material (e.g., aluminum). As shown in FIGS. 11 and 12, the ferrule 70 has a bottomed cylindrical shape having a first ferrule member 71 for covering the circumferential surface of the glass tube 30 and a second ferrule member 72 for covering the end surface of the glass tube 30. The first ferrule member 71 and the second ferrule member 72 are removable.

The first ferrule member 71 is in a cylindrical shape, with its end surface 71a slightly protruded from an end surface of the glass tube 30 in the axial direction. The end surface 71a of the first ferrule member 71 faces a direction substantially perpendicular to the axial direction of the glass tube 30. Furthermore, an engagement piece receiving portion 73 is formed in the area within the inner circumference slightly outside than the end surface of the glass tube 30 (see FIG. 12). An engaging piece 75 of the second ferrule member 72, which will be described later, is engaged with the engagement piece receiving portion.

The end surface 71a of the first ferrule member 71 is in contact with a first lead wire 80a and a second lead wire 80b pulled out from the glass tube 30. Both lead wires 80a and 8b are pulled out from the glass tube 30 along the axial direction of the glass tube 30. Then, they are bent such that a portion of each lead wire 80a or 80b that overlaps the end surface 71a of the first ferrule member 71 extends toward the first ferrule member 71. Namely, they are bent so as to extend in a direction substantially perpendicular to the axial direction of the glass tube 30 and come in contact with the end surface 71a.

The second ferrule member 72 includes an end portion 74 in a disc shape opposed to the end surface of the glass tube 30 and an engaging piece 75 made of an elastic member standing up from the central part of the end portion 74. The engaging piece 75 engages with the engagement piece receiving portion 73 of in the first ferrule member 71 with the elastic deformation. It has a function of restricting the second ferrule member 72 from unexpectedly coming off of the first ferrule member 71. The power input terminals 45a and 45b are mounted in areas of the end portion 74 of the second ferrule member 72 opposed to where lead wires 80a and 80b are in contact with the end surface 71a of the first ferrule member 71. The power input terminals 45a and 45b come in contact with the lead wires 80a and 80b, respectively. The power input terminals 45a and 45b are not covered with the outer end surface 74a of the end portion 74. When they come in contact with the power output terminals 60 and 61 of the relay connector 19, the electrical connection therebetween is established.

How to attach the ferrule 7 including the first ferrule member 71 and the second ferrule member 72 to the glass tube 30 is described below in reference to FIG. 13. Firstly, the first ferrule member 71 in a cylindrical shape is attached to the end of the glass tube 30. The end surface 71a of the first ferrule member 71 is positioned slightly outside the end surface of the glass tube 30 in the axial direction. Next, two lead wires 80a and 80b pulled out from the glass tube 30 in the axial direction thereof are bent in a direction substantially perpendicular to the axial direction of the glass tube 30. They are bent such that the portion of each lead wire 80a or 80b that overlaps the end surface 71a of the first ferrule member 71 extends in the direction substantially perpendicular to the axial direction of the glass tube 30. More particularly, they are bent in the opposite directions toward the first ferrule member 71. This bending work is performed by hands or a bending jig. The tips of the lead wires 80a and 80b are in contact with the end surface 71a of the first ferrule member 71 but not projected from the outer circumferential surface of the first ferrule member 71. Next, the second ferrule member 72 is brought closer to the end surface of the glass tube 30 along the axial direction of the glass tube 30. The power input terminals 45a and 45b of the second ferrule member 72 hold the second ferrule member 72 such that the power input terminals 45a and 45b face the tips of the bent lead wires 80a and 80b, respectively. Then, with the elastic deformation, the engaging piece 75 of the second ferrule member 72 engages with the engagement piece receiving member 73 of the first ferrule member 71. As a result, the second ferrule member 72 is attached to the first ferrule member 71. This completes the mounting of the ferrule 70 to the glass tube 30.

According to the present embodiment, the first lead wire 80a and the second lead wire 80b are pulled out from the glass tube 30 along the axial direction of the glass tube 30. They are bent in a direction along the end surface 71a of the first ferrule member 71 of the ferrule 70 that is attached to the end of the glass tube 30. Namely, they are bent in a direction substantially perpendicular to the axial direction of the glass tube 30. Because the lead wires 80a and 80b are bent in a direction substantially perpendicular to the axial direction of the glass tube 30, the apparent lengths of the lead wires 80a and 80b are equal to the length between the end of the glass tube 30 and the bent part. Therefore, the apparent lengths of the lead wires 80a and 80b with respect to the whole length of the hot cathode fluorescent lamp 17 can be reduced as much as possible. As a result, the light emitting area of the hot cathode fluorescent lamp 17 further increases.

### Other Embodiments

The present invention is not limited to the above embodiments described in the above description with reference to the accompanying figures. For example, the following embodiments may be included in the technical scope of the present invention.

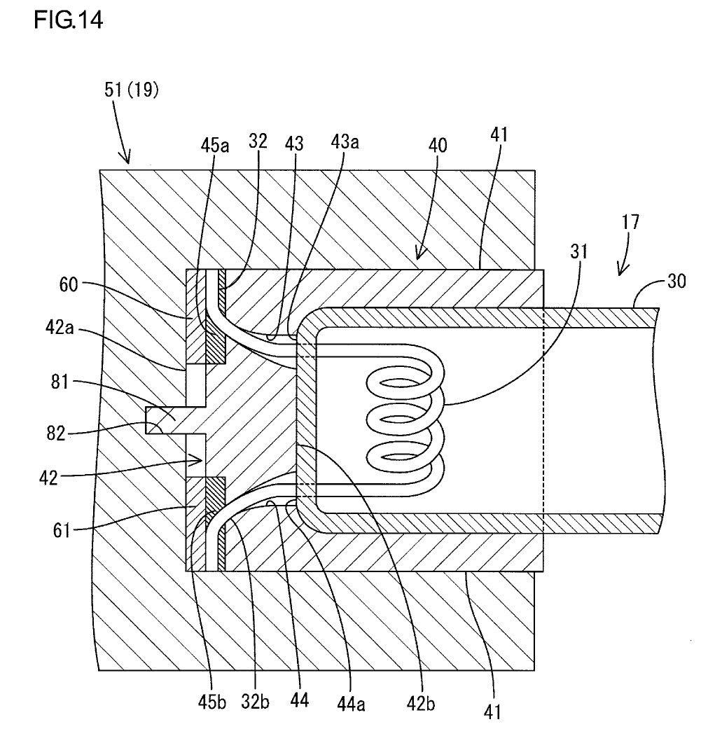

(1) In the above embodiments, the grooved portion 46 of the ferrule 40 and the protruding portion 57 of the socket 51 are fitted together. However, a grooved portion and a protruding portion shown in FIG. 14 may be used. In particular, the protruding portion 81 that protrudes toward the socket 51 is formed on the outer end surface 42a of the ferrule 40 and a grooved portion 82 that is formed in the socket 51 of the relay connector 19 toward the far side from the ferrule 40. Engaging the protruding portion 81 with the grooved portion 82 decides a position at where the hot cathode fluorescent lamp 17 is connected with the relay connector 19.

(2) In the above embodiments, the continuously extending protruding portion is fitted in the continuously extending grooved portion. However, one or a plurality of the protrusions may be fitted in one or a plurality of the recesses s.

(3) In the above embodiments, the power output terminals 60 and 61 of the relay connector 19 are elastic members. However, the power input terminal of the ferrule may be an elastic member.

(4) In the above embodiments, two lead wires pulled out from a glass tube are connected with two power input terminals that are electrically independent from each other, respectively. However, the lead wires may be connected to a single power input terminal if the power level and timing of the power supply to the lead wires are not different from wire to wire. Furthermore, the number of the lead wires pulled out of the glass tube may be changed depending on how to supply power to the discharge tube.

(5) In the above embodiments, the hot cathode fluorescent lamp 17 is shown as an example of a discharge tube. However, other kinds of discharge tubes such as a cold cathode fluorescent lamp may be included in the scope of the present invention.

1. A discharge tube comprising:
a glass tube;
a ferrule attached to an end of the glass tube; and
a lead wire provided at the end of the glass tube, wherein the lead wire is bent and inserted in the ferrule such that the lead wire is in contact with the ferrule, and electrically connected to an external power supply via the ferrule.

2. The discharge tube according to claim 1, wherein the ferrule includes an end portion having an inner bottom surface opposed to an end surface of the glass tube and having an outer end surface substantially perpendicular to the axial direction of the glass tube.

3. The discharge tube according to claim 2, wherein:
the end portion of the ferrule has an insertion hole in which the lead wire is inserted; and
the insertion hole is formed such that an axis thereof curves from the axial direction of the glass tube to a direction that crosses the axial direction of the glass tube.

4. The discharge tube according to claim 2, wherein the lead wire is bent in a direction substantially perpendicular to the axial direction of the glass tube.

5. A lighting device comprising:
the discharge tube according to claim 1;
an external power source for supplying power to the discharge tube; and
a chassis provided as a mounting body of the discharge tube and the external power source.

6. The lighting device according to claim 5, further comprising a relay connector for making electrical connection between the external power source and the discharge tube, the relay connector arranged in the chassis, wherein the relay connector has a ferrule receiving portion in which the ferrule of the discharge tube is fitted to supply power to the discharge tube.

7. The lighting device according to claim 6, wherein:
the ferrule includes an end portion having an inner bottom surface opposed to an end surface of the glass tube;
the end portion has an outer end surface in which a recess is formed toward a glass tube side;
the relay connector includes a protrusion that protrudes toward a ferrule side on a surface of the ferrule receiving portion that is opposed to the outer end surface of the ferrule; and
the discharge tube is mounted to the relay connector in a position defined by fitting the protrusion of the ferrule receiving portion in the recess of the ferrule.

8. The lighting device according to claim 6, wherein:
the ferrule includes an end portion having an inner bottom surface opposed to an end surface of the glass tube;
the end portion has a protrusion that protrudes toward a ferrule receiving portion side on an outer end surface;
the ferrule receiving portion has a surface that is opposed to the outer end surface of the ferrule and in which a recess is formed toward an opposite side from the ferrule side; and
the discharge tube is mounted to the relay connector in a position defined by fitting the protrusion of the ferrule in the recess of the ferrule receiving portion.

9. The lighting device according to claim 6, wherein:
the ferrule includes an end portion having an inner bottom surface opposed to an end surface of the glass tube and a power input terminal at the end portion for receiving electrical power, the input terminal being in contact with the lead wire;
the relay connector includes a power output terminal for supplying electrical power, the power output terminal electrically connected to the external power source on a surface of the ferrule receiving portion that is opposed to the outer end surface of the ferrule; and
the discharge tube is electrically connected to the external power source through a contact between the power input terminal and the power output terminal.

10. The lighting device according to claim 9, wherein at least one of the power input terminal and the power output terminal is made of an elastic member.

11. A display device comprising:
the lighting device according to claim 5; and
a display panel configured to provide display using light emitted from the lighting device.

12. The display device according to claim 11, wherein the display panel is a liquid crystal panel.

13. A television receiver comprising the display device according to claim 11.
